(19) United States
(12) Patent Application Publication
(10) Pub. No.: US 2014/0172496 A1
(43) Pub. Date: Jun. 19, 2014

(54) Automatic Management of Accidents Using Rules for Starting Post-Accident Procedures

(71) Applicants: Martin Rosjat, Dresden (DE); Stefan Hesse, Dresden (DE)

(72) Inventors: Martin Rosjat, Dresden (DE); Stefan Hesse, Dresden (DE)

(21) Appl. No.: 13/719,845

(22) Filed: Dec. 19, 2012

(51) Int. Cl. G06Q 10/06

(52) U.S. Cl. CPC G06Q 10/0635
USPC 705/7.28

(57) ABSTRACT

Implementations of the present disclosure are directed to automatically monitoring occurrence and initiating actions in response to accidents in operations of an enterprise with actions including receiving a plurality of vehicle data sets, each vehicle data set corresponding to a vehicle of a plurality of vehicles that support the operations of the enterprise, receiving a set of accident rules from a data repository, processing a vehicle data set based on the set of accident rules, and determining that a vehicle corresponding to the data set was in an accident, and in response: determining one or more remedial actions to be performed, identifying one or more entities, each entity performing at least one remedial action of the one or more remedial actions, and transmitting a plurality of instruction data sets to the one or more entities, each entity of the one or more entities receiving at least one instruction data set.

### BACKGROUND

Enterprises, such as manufacturing companies, include numerous operations. Example operations can include sales, manufacturing and supply. For example, supply chains include the transportation of goods from providers to customers. The use of vehicles in enterprise operations (e.g., sales calls, the transportation of goods) is associated with the risk of accidents. In risk management, companies strive to understand and mitigate the possible risks, but despite these efforts, events caused by external factors outside of their control may occur that were not anticipated. This means that enterprises (e.g., suppliers and/or customers) must respond to accidents, which can occur anytime. In some cases, an accident can lead to problems that require immediate, short-term and/or long-term remediation.

### SUMMARY

Implementations of the present disclosure include computer-implemented methods for automatically monitoring occurrence and initiating actions in response to accidents in operations of an enterprise, the methods being performed using one or more processors and including actions of receiving a plurality of vehicle data sets, each vehicle data set corresponding to a vehicle of a plurality of vehicles that support the operations of the enterprise, receiving a first set of accident rules from a data repository, processing a first vehicle data set based on the first set of accident rules, and determining that a first vehicle corresponding to the first data set was in an accident, and in response: determining one or more remedial actions to be performed, identifying one or more entities, each entity performing at least one remedial action of the one or more remedial actions, and transmitting a plurality of instruction data sets to the one or more entities, each entity of the one or more entities receiving at least one instruction data set.

In some implementations, actions further include receiving a set of action rules, wherein determining one or more remedial actions includes processing data based on the one or more action rules.

In some implementations, the data includes at least a portion of data in the first vehicle data set, and additional data.

In some implementations, the set of action rules is specific to at least one of a vehicle type of the first vehicle and a severity of the accident.

In some implementations, actions further include determining a severity of the accident based on the first vehicle data set, the one or more remedial actions being determined at least in part based on the severity of the accident.

In some implementations, the one or more entities include at least one internal entity that is internal to the enterprise.

In some implementations, the internal entity includes one of a human resources department, a vehicle fleet maintenance department, a procurement department, a shipping department, a manufacturing department, a sales department, a legal department of the enterprise.

In some implementations, the one or more remedial actions include at least one action that mitigates a delay in moving goods within a supply chain that the enterprise is a member of.

In some implementations, the one or more entities include at least one external entity that is external to the enterprise.

In some implementations, the external entity includes at least one of an emergency service provider, a healthcare service provider, a police department, a fire department, an insurance provider, a vendor and a customer.

In some implementations, data provided in the first vehicle data set includes one or more of event data and operational data.

In some implementations, the event data is indicative of one or more events including at least one of a crash, airbag deployment, rollover, windscreen breakage, wheel puncture, engine failure and transmission failure.

In some implementations, the operational data includes one or more of velocity, acceleration, braking, engine data and transmission data.

In some implementations, the first set of accident rules is specific to a vehicle type of the first vehicle.

In some implementations, actions further include receiving a second set of accident rules from a data repository, the second set of accident rules being different from the first set of accident rules, processing a second vehicle data set based on the second set of accident rules, and determining that a second vehicle corresponding to the second data set was in an accident.

In some implementations, actions further include receiving, from each of the one or more entities, status data indicating statuses of respective executions of the one or more remedial actions.

In some implementations, actions further include determining additional actions to be performed based on the status data.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 is a block diagram of an example system architecture that can execute implementations of the present disclosure.

FIG. 2 is a block diagram of an example system architecture that can execute implementations of the present disclosure.

FIG. 3 is a flowchart depicting an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to automatic management of accidents using rules for initiating and monitoring post-accidents procedures. In particular, implementations of the present disclosure are directed to collecting vehicle data from one or more vehicles used in operations of an enterprise and to determine the occurrence of an accident based on the collected vehicle data. In some implementations, the vehicle data is processed in view of one or more rules. In some implementations, and in response to determining that an accident has occurred, one or more actions are determined. In some examples, the one or more actions are provided to one or more entities, each entity being responsible for executing at least one action. In some examples, vehicle data and/or accident data can be provided to one or more entities. In this manner, an entity can execute the at least one action based on the received data. In some examples, an entity can process the data and/or other data to identify and execute one or more auxiliary actions. In some examples, at least one auxiliary action can be assigned to another entity from the entity.

In some implementations, an enterprise can be associated with one or more vehicles. Example vehicles can include cars and trucks (e.g., fleet vehicles), as well as operations vehicles. In some examples, operations vehicles can include vehicles that are used within a facility (e.g., factory) of the enterprise. An example operations vehicle can include a forklift. In some examples, vehicles can include company vehicles used by employees of the enterprise (e.g., sales-persons that use the vehicles to visit customers). In some examples, vehicles can include cars and/or trucks used in the supply chain of an enterprise. For example, the enterprise can use vehicles to provide goods to a customer. As another example, the enterprise can use vehicles to receive goods from a supplier.

In some implementations, vehicle data can be collected for each vehicle and can be transmitted for processing by a backend system. In some examples, a data collection system is provided in the vehicle to monitor vehicle operation and to collect vehicle data based thereon. The data collection system can transfer data to the backend system. In some examples, vehicle data can include operational data, vehicle location data, driver data and/or meteorological data. Example vehicle data is discussed in further detail herein. In some examples, vehicle data is collected during operation of the vehicle. In some examples, and as discussed in further detail below, vehicle data can be provided from one or more data repositories. For example, a data repository can store information associated with a driver of a particular vehicle, which data can be provided to the backend system from the data repository.

In some implementations, the backend system processes the vehicle data to determine whether an accident has occurred. In some examples, if an accident has occurred, the vehicle data can be processed to determine one or more remedial actions that are to be performed. In some examples, additional data can be retrieved. For example, additional data can be requested from the vehicle involved in the accident, and/or from the operator of the vehicle. As another example, additional data can be requested from one or more data repositories, as discussed in further detail herein. In some examples, the one or more remedial actions can be determined based on the vehicle data and the additional data.

In some implementations, the vehicle data and/or the additional data (the data) can be processed based on one or more rules. In some examples, the backend system can include various rules, logic algorithms and/or regulations to identify the occurrence of an accident. In some examples, an accident rule set can be selected to be used to determine whether an accident has occurred. In some examples, an accident rule set can be selected based on the type of vehicle being considered. For example, if the vehicle includes a shipping truck, a first accident rule set can be selected and the data can be processed in view of the first accident rule set. If the vehicle includes a car, a second accident rule set, which is different from the first accident rule set, can be selected and the data can be processed in view of the second accident rule set.

In some implementations, if it is determined that an accident has occurred, an action rule set can be selected. In some examples, the data is further processed in view of the action rule set to determine the one or more remedial actions that are to be performed in response to the accident. In some examples, the action rule set can be selected based on the type of vehicle being considered, the operator of the vehicle, the driver of the vehicle, a type of the accident and/or a severity of the accident. For example, if the vehicle includes a shipping truck, a first action rule set can be selected and the data can be processed in view of the first action rule set. If the vehicle includes a car, a second action rule set, which is different from the first action rule set, can be selected and the data can be processed in view of the second action rule set. As another example, if the vehicle includes is owned and operated by the enterprise, a first action rule set can be selected and the data can be processed in view of the first action rule set. If the vehicle is owned and operated by another entity (e.g., the enterprise contracts for the user of the vehicle), a second action rule set, which is different from the first action rule set, can be selected and the data can be processed in view of the second action rule set. As another example, if the accident is determined to be relatively minor (e.g., the vehicle has broken down), a first action rule set can be selected and the data can be processed in view of the first action rule set. If the accident is determined to be a relatively major accident (e.g., significant vehicle damage, potential injuries), a second action rule set, which is different from the first action rule set, can be selected and the data can be processed in view of the second action rule set.

In some examples, the one or more remedial actions can be performed by one or more entities. In some examples, the one or more entities can include one or more internal entities (e.g., an entity within the enterprise) and/or one or more external entities (e.g., an entity that is external to the enterprise). Example internal entities can include departments within the enterprise (e.g., a human resources department, a vehicle fleet maintenance department, a procurement department, a shipping department, a manufacturing department, a sales department, a legal department). Example external entities can include an emergency response service (e.g., police department, fire department, an ambulance service), a customer and an insurance provider. In some examples, vehicle data and/or additional data can be provided to an entity. In this manner, the entity can execute at least on remedial action based on the received data.

In accordance with implementations of the present disclosure, the impact of each accident (e.g., disrupted supply of a product and/or personnel redistribution) can be managed. For example, it can be determined that the vehicle involved in the accident is not repairable, and a vehicle procurement process can be initiated as a remedial action to permanently or temporarily replace the vehicle. As another example, it can be determined that the payload of the vehicle is effectively destroyed, and a manufacturing process can be initiated as a remedial action to replace the destroyed products. As another example, it can be determined that the payload of the vehicle is intact, and another vehicle can be dispatched to retrieve the payload and continue with the shipment of the payload. Other example, non-emergency remedial actions are discussed in further detail herein.

In some cases, remedial actions can include emergency remedial actions such as, for example, first aid support, notification of the authorities (e.g., police, fire, hazard material containment). For example, if it is determined that an accident might require first aid support, remedial actions can be immediately dispatched to external entities such as police, fire, ambulance and/or hospital.

In accordance with implementations of the present disclosure, accidents directly affecting the supply chain of the enterprise, and/or the overall operations of the enterprise can be quickly and efficiently mitigated. For example, to diminish the impact of the accident on the supply chain, implementations of the present disclosure quickly and efficiently provide relevant information that can be automatically processed to react quickly to the accident, assess the impact, determine the appropriate actions and implement the actions.

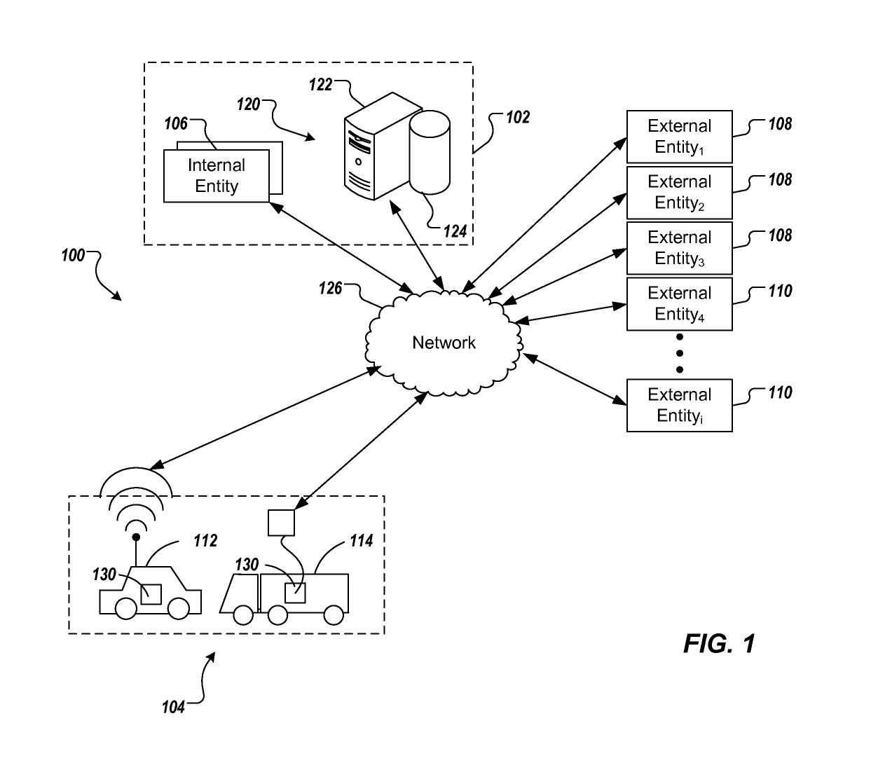

FIG. 1 is a block diagram of an example system 100 that can execute implementations of the present disclosure. In some implementations, the example system 100 can be associated with an enterprise 102 or, more generally, operations of the enterprise 102. In an example context, the enterprise 102 can include a company that sells, manufactures and transports products using one or more vehicles within a vehicle fleet 104. It is appreciated that implementations of the present disclosure can be used in other appropriate contexts.

In the depicted example, the enterprise 102 can include one or more internal entities 106 that support operations of the enterprise 102. Example internal entities 106 can include a human resources department, a vehicle fleet maintenance department, a procurement department, a shipping department, a manufacturing department and a sales department. In the depicted example, the enterprise 102 can interact with one or more external entities 108 that support operations of the enterprise 102. Example external entities 108 can include suppliers, customers, insurance providers and the like. In the depicted example, the enterprise 102 can interact with one or more external entities 110 that support responses to accidents. Example external entities 110 can include local, state and/or federal agencies (e.g., fire, police, hazmat response) and/or response entities (e.g., hospital, ambulance).

In accordance with implementations of the present disclosure, a backend system 120 can be associated with the enterprise 102. In some examples, the backend system includes one or more computing devices 122 and one or more data repositories 124 (e.g., databases). In some examples, the one or more computing devices 122 executed one or more computer-executable programs that provide functionality discussed herein. In some examples, the backend system 120 sends and receives data from other components, as discussed herein. For example, the backend system 120 can communicate data using a network 126. In some implementations, the network 126 can include a large computer network, such as a local area network (LAN), a wide area network (WAN), the Internet, a cellular network, or a combination thereof connecting any number of mobile computing devices, fixed computing devices and server systems.

In some implementations, the backend system 120 can be an on-premise system that is located at a location associated with the enterprise 102.

In some implementations, the backend system 120 is provided by a third-party service provider that hosts and operates the backend system 120 on behalf of the enterprise 102. For example, the enterprise can outsource processing of the vehicle data and determination of remedial actions following an accident to the third-party service provider. In some examples, the third-party service provider can manage access to the vehicle data. For example, the third-party service provider can manage and maintain a central database that can be accessed by multiple enterprises. For example, each enterprise can store vehicle data and/or human data (e.g., for personnel operating a vehicle) for sharing with other enterprises. For example, one or more other enterprises associated with vehicles provided in the vehicle group 104 (e.g. contractors) can provide vehicle data to the third-party service provider.

In the depicted example, the vehicle fleet 104 includes one or more cars 112 and/or one or more trucks 114. It is appreciated, however, that the vehicle fleet 104 can include any number of vehicles and/or types of vehicle (e.g., cars, trucks, scooters, motorcycles, forklifts). In some examples, the vehicles in the vehicle fleet 104 can include vehicles that are owned and operated by the enterprise 102. In some examples, the vehicles in the vehicle fleet 104 can include vehicles that are owned and operated by a third-party (e.g., an external entity 108) and that contracts with the enterprise 102. For example, the vehicle group 104 can include any type of outsourced shipping vehicle (e.g., cars, trucks, maritime vessels, aircraft and/or trains), which could provide services for products produced by and/or supplied by the enterprise 102, and/or raw materials provided to the enterprise 102. In some examples, outsourced vehicles can be operated by one or more other enterprises, such as supplier enterprises. In some examples, each of the one or more other enterprises can collect and provide vehicle data for processing by the backend system 120.

In accordance with implementations of the present disclosure, each vehicle includes a data collection system 130 associated therewith. In some examples, each data collection system 130 includes one or more sensors that are responsive to operation of the vehicle. For example, each data collection system 130 can be responsive to and can record vehicle data. In some examples, each data collection system 130 can communicate with the backend system 120 over the network 126. For example, each data collection system 130 can provide vehicle data (e.g., operational data, vehicle location data, human data, meteorological data) to the backend system 120 over the network 126. In some examples, data collection systems 130 can include components that are already provided with the vehicle to provide functionality discussed herein. In some examples, data collection systems 130 can include special-purpose components that are integrated into a vehicle to provide functionality discussed herein.

In some examples, each vehicle and/or data collection system 130 can include a unique identifier associated therewith. In this manner, vehicle data generated by and received from a particular data collection system 130 can be associated with the unique identification number for processing and storage in the backend system 120. In some examples, each vehicle is associated with a unique identifier (vehicle identifier) that can be cross-referenced to a data collection system identifier of the data collection system 130 provided with the vehicle. In this manner, vehicle data received from a particular data collection system 130 can also be associated with the particular vehicle from which the vehicle data was collected.

In some implementations, data collection systems 130 can include one or more devices for communicating vehicle data to the backend system 120. For example, each data collection system 130 can directly communicate vehicle data to the backend system 120 over the network 126. In some examples, a data collection system 130 can transmit vehicle data to one or more intermediate computing devices, and the one or more intermediate computing devices can transmit the vehicle data to the backend system 120 over the network 126. For example, an intermediate computing device can include a handheld device, such as a smartphone executing an application, that can receive vehicle data from the data collection system 130 and that can send the vehicle data to the backend system 120. In some examples, the application executed on the smartphone can perform functionality to collect and send the vehicle data to the backend system 120. As another example, the intermediate computing device can include a local computing device associated with a facility. In some examples, the local computing device can communicate (e.g., using wired communication and/or wireless communication) with one or more data collection systems 130 to receive vehicle data from the data collection systems 130. The local computing device can transmit the vehicle data to the backend system 120. In some implementations, vehicle data can be transmitted to the backend system 120 using a web service. For example, the vehicle data can be transferred to the backend system 120 using an HTTP or a secure HTTPS protocol. In some implementations, the data recorded by the data collection system 130 of each vehicle can be stored in a memory included in the vehicle for later transfer over the network 126 to the backend system 120.

In some implementations, vehicle data can include event data and operational data. In some examples, event data can indicate the occurrence of a discrete event. Example events can include a crash, airbag deployment(s), rollover, windscreen breakage, wheel puncture(s), engine failure, transmission failure and the like. For example, one or more crash sensors can generate signals indicating that the vehicle has been involved in a crash (e.g., the vehicle hit something and/or something hit the vehicle with sufficient force to generate a crash signal). In some examples, multiple crash sensors can be provided in the sensor system 130 and can generate respective signals depending on which side of the vehicle is struck. In this manner, the point(s) of impact about the perimeter of the vehicle can be determined. As another example, one or more airbag deployment sensors can generate signals indicating deployment of a respective airbag. In some examples, multiple airbag deployment sensors can be provided in the data collection system 130 and can generate respective signals depending on which side of the vehicle is struck. In this manner, the point(s) of impact about the perimeter of the vehicle can be determined (e.g., head-on crash, side-impact). As another example, a rollover sensor can generate a signal indicating that the vehicle has rolled over.

In some examples, operational data can include velocity, acceleration, braking, engine data, transmission data and the like. For example, a velocity sensor (e.g., wheel speed sensor) can generate signals indicating the velocity of the vehicle and/or acceleration of the vehicle. As another example, a braking sensor (e.g., ABS-ring sensor) can generate signals indicating whether braking is being or has been applied and to what degree. As another example, one or more engine sensors can generate signals indicating engine speed (e.g., RPM), engine torque, engine oil temperature, engine oil quality and/or engine coolant temperature. As another example, one or more transmission sensors can generate signals indicating gears in which the transmission is or was operating, transmission fluid temperature and/or transmission fluid quality.

In some examples, operational data can include global positioning system (GPS) data that can be used to determine a location of the vehicle, the route that the vehicle traveled, and/or a velocity and acceleration history of the vehicle among other information.

In some implementations, the vehicle data recorded by each data collection system 130 can be transmitted to the backend system 120 over the network 126. In some examples, the vehicle data is periodically transmitted to the backend system 120. For example, batch vehicle data (e.g. vehicle location) can be transmitted at pre-defined intervals (e.g., minutely or hourly). In some examples, the vehicle data is transmitted to the backend system 120 in response to an event (e.g., a collision, an engine fault, a transmission fault). In some examples, vehicle data can be transmitted in real-time over the network 126 to the backend system 120. For example, vehicle data can be continuously transmitted to the backend system 120 as the vehicle data is recorded by the sensor system 130.

As discussed in further detail herein, the backend system 120 can process the vehicle data to determine whether an accident has occurred, and to identify and implement remedial actions in response to the accident. In some implementations, the backend system 120 conforms to a particular protocol. For example, the backend system 120 receives vehicle data from data collection systems 130 incorporated in multiple vehicles. In some examples, the backend system 120 can process the vehicle data according to a set of rules. In some implementations, an output of the backend system 120 can be a confirmation of the occurrence of an accident. In some examples, the backend system 120 can further provide one or more types of accident. Example types of accidents can include vehicle breakdown, collision, head-on collision, rear-end collision, side-impact collision and rollover. In some examples, the backend system 120 can provide a severity of the accident.

In some implementations, the backend system 120 identifies one or more remedial actions based on vehicle data, additional data, the type(s) of accident and/or the severity of the accident. In some implementations, the backend system 120 can coordinate the implementation of the actions between entities. For example, the backend system 120 can communicate with an entity (e.g., an internal entity 106 or an external entity 108, 110) and can provide additional data received from the entity to another entity (e.g., an internal entity 106 or an external entity 108, 110). In some examples, the backend system 120 can notify the enterprise 102 of the accident and determined actions. For example, the enterprise 102 can include a system, discussed in further detail below, that can receive accident information and can perform one or more actions in response thereto. In some examples, the enterprise 102 can select how to implement the determined actions. In some examples, the backend system 120 can automatically implement the determined actions according to a set of rules.

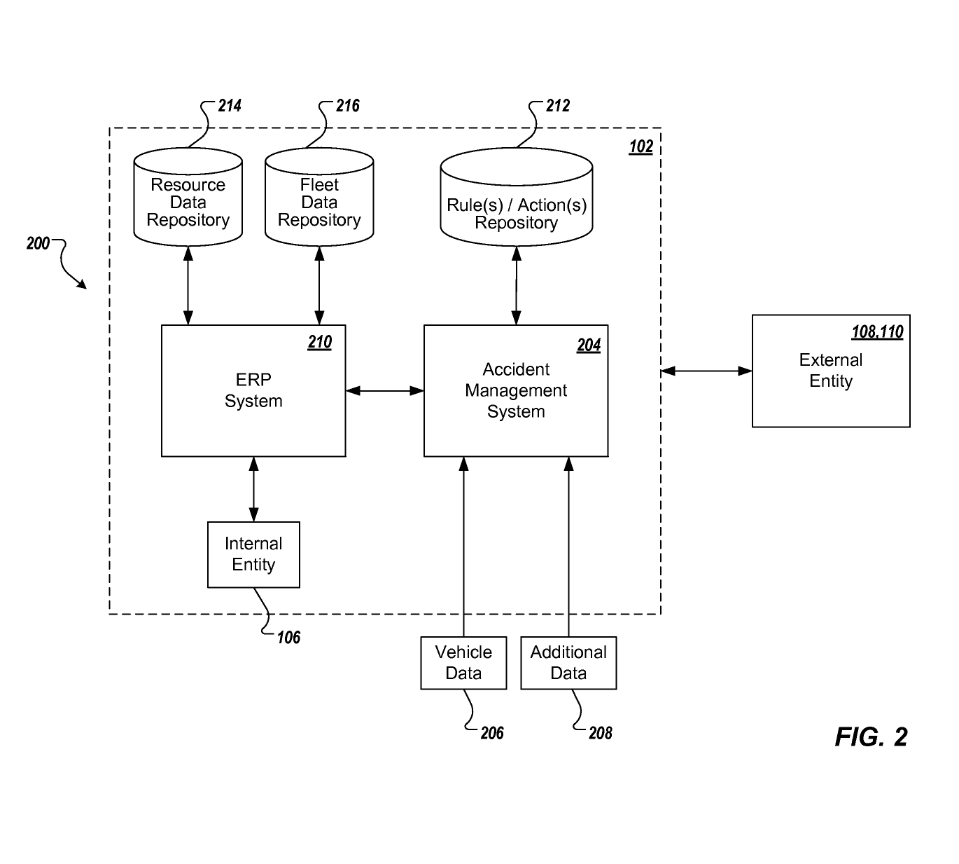

FIG. 2 depicts an example system 200 that can be used to execute implementations of the present disclosure. In the depicted example, the example system 200 can be provided by the enterprise 102, and can include an accident management system 204 and an operations system 210. In the depicted example, the operations system 210 includes an enterprise resource planning (ERP) system. Although a single operations system 210 is depicted, implementations of the present disclosure can be used with multiple operations systems 210. In some examples, each of the accident management system 204 and the operations system 210 are provided as one or more computer-executable programs that can be executed using one or more computing devices (e.g., in the backend system 120 of FIG. 1). In some examples, the accident management system 204 can receive vehicle data 206 and/or additional data 208. In some examples, the accident management system 204 can retrieve one or more sets of rules from a repository 212.

In the depicted example, the operations system 210 can communicate with a resource data repository 214 and a fleet data repository 216. In some examples, the operations system 210 can retrieve data from and/or provide data to each of the resource data repository 214 and the fleet data repository 216. In some examples, the resource data repository 214 stores data associated with one or more resources of the enterprise 102. Example resources can include human resources (e.g., employees) and non-human resources (e.g., equipment, raw materials, products). In some examples, the fleet data repository 216 stores data associated with one or more vehicles in the vehicle fleet of the enterprise.

In some implementations, the accident management system 204 receives the vehicle data 206 and/or auxiliary data 208. In some examples, a plurality of vehicle data sets can be provided, each vehicle data set corresponding to a particular vehicle. In some implementations, the accident management system 204 can process the received data to determine whether an accident has occurred. In some examples, the accident management system 204 can receive an accident rule set from the repository 212. In some examples, the accident management system 204 processes the received data based on the accident rules to determine whether an accident has occurred. For example, an example accident rule can provide that if one or more crash sensors indicate the occurrence of an accident, it is determined that an accident has occurred. As another example, an example accident rule can provide that if an airbag sensor indicates deployment of an airbag, it is determined that an accident has occurred.

In some cases, indication of an accident might not be as explicit. More complex accident rules can be provided to determine whether an accident has occurred. An example accident rule can provide that if the vehicle has been stationary for a pre-determined period of time and the vehicle is located in a particular type of location (e.g., in a remote location), it is determined that an accident (e.g., punctured tire, breakdown) has occurred.

In some examples, an example accident rule can be applied to determine that an accident has likely occurred (e.g., the vehicle has been stationary for a pre-determined period of time and the vehicle is located in a remote location). Consequently, the accident management system 204 can request additional data. For example, the action management system 204 can communicate with the data collection system 130 of the vehicle to request additional data. As another example, the accident management system 204 can call the operator of the vehicle (e.g., through a communications device provided with the data collection system, through a mobile device of the operator of the vehicle). As another example, the accident management system 204 can provide instructions to a human employee of the enterprise to contact the operator of the vehicle.

In some examples, the accident rule set can be specific to the vehicle type of the vehicle associated with the received data. For example, a first accident rule set can be associated with a shipping truck. An example accident rule of the first accident rule set can provide that if the vehicle has been stationary for a pre-determined period of time at a non-enterprise or a non-customer location, an accident is determined to have occurred (e.g., a shipping truck might be expected to be at an enterprise location, a customer location or moving between such locations). A second accident rule set can be associated with a car used by sales representatives of the enterprise. An example accident rule of the second accident rule set can provide that if the vehicle has been stationary for a pre-determined period of time at a non-enterprise or a non-customer location, an accident is determined not to have occurred (e.g., a car used by a sale representative might be expected to be used to take customers to non-enterprise and/or non-customer locations, such as to dinner or lunch).

In some implementations, if it is determined that an accident has occurred, the data can be further processed to determine a severity of the accident. More particularly, the vehicle data 206 can include information indicative of an accident occurrence, type of accident (e.g. collision, malfunction, weather related, etc.) and preconditions of the accident (e.g. velocity of vehicle before the accident). In some implementations, the accident management system 204 processes the data to analyze vehicle sensor data, medical data, vehicle location data and other relevant data to determine the severity of the accident. In some examples, event data can explicitly indicate a severity of the accident. For example, if a crash sensor indicates the occurrence of a collision, but the airbag sensors do not indicate that any airbags were deployed, it can be determined that the accident is a mild accident. As another example, if the vehicle has been static for a predetermined period of time and a tire pressure sensor indicates a flat tire, it can be determined that the accident is not severe.

In some cases, the severity of the accident can further be determined based on pre-condition (pre-accident) data. In some examples, vehicle speed prior to occurrence of the accident can be analyzed. For example, if a crash sensor indicates the occurrence of a collision and the vehicle speed immediately prior to the crash sensor indication is a relatively high velocity, it can be determined that the accident is a very severe accident. As another example, if a crash sensor indicates the occurrence of a collision and the vehicle speed immediately prior to the crash sensor indication is a relatively low velocity, it can be determined that the accident is not a sever accident.

In some implementations, and in response to determining that an accident has occurred, the accident management system 204 can determine one or more remedial actions that are to be performed and can dispatch instructions and data to entities that are tasked with performing the remedial actions. In some examples, the accident management system 204 receives a set of action rules from the repository 212. In some examples, the data is processed based on the action rules to determine the remedial actions that are to be performed. Example actions can include informing an insurer of the accident and providing relevant data, providing emergency response to the accident, dispatching another vehicle to retrieve the payload and continue delivery of the payload, and initiate a manufacturing process to replace goods lost in the accident. In some example, data can be provided to assist in execution of the remedial actions. For example, a type and quantity of goods that need to be replaced can be provided. As another example, a size and weight of the payload that is to be retrieved can be provided, to ensure that a vehicle that is dispatched to retrieve the goods is of sufficient size.

In some implementations, the one or more remedial actions can be determined based on the severity of the accident. For example, if the accident is determined not to be severe, emergency responders might not be required. As another example, if the accident is determined to be very sever the actions can include dispatching emergency responders.

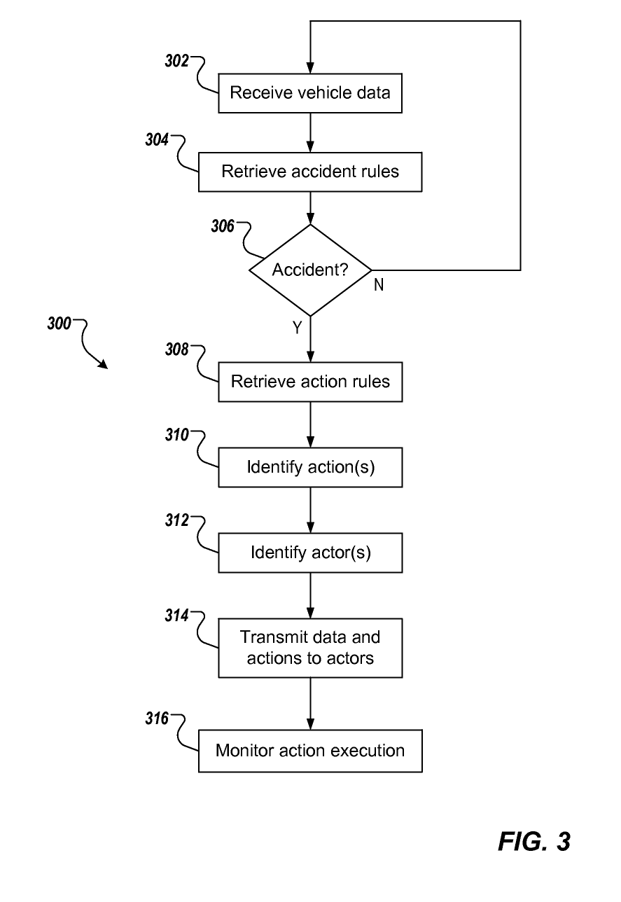

FIG. 3 depicts an example process 300 that can be executed in accordance with implementations of the present disclosure. In some implementations, the example process 300 can be implemented using one or more computer-executable programs that can be executed using one or more processors. For example, the example process 300 can be executed by the backend system 120 of FIG. 1.

Vehicle data is received (302). For example, vehicle data can be recorded and transmitted to the backend system 120 from respective data collection systems 130 (see FIG. 1). Accident rules are retrieved (304). For example, a set of accident rules is retrieved from a repository (e.g., the repository 212 of FIG. 2). In some examples, the set of accident rules is selected based on a type of vehicle from which the vehicle data was received. It is determined whether an accident has occurred (306). In some examples, the vehicle data is processed based on the accident rules to determine whether an accident has occurred. In some examples, if it is determined that an accident has not occurred, the example process 300 loops back. In some examples, if it is determined that an accident has occurred, a type of accident and/or a severity of the accident can be determined (e.g., collision, vehicle malfunction, medical condition and/or weather related).

If it is determined that an accident has occurred, a set of action rules is selected (308). In some examples, the set of action rules can be selected based on the vehicle type, the vehicle data, the accident type and/or the severity of the accident. One or more remedial actions are identified based on the set of action rules and the received data (310). For example, actions can include contacting and transmitting at least a part of vehicle data to an external entity (e.g., the external entity 108, 110). As another example, and in the example case of a collision with critical medical condition, actions could include contacting police, hospital and a supply chain management center. Actors are identified (312). For example, actors can include internal entities (e.g. supply chain management center) and/or external entities (e.g. hospital, police, contractors, road assistants, customers, etc.). Data and actions are transmitted to the actor(s) (314). For example, it can be determined that the supply chain management center is identified as an actor in contacting a customer to address a possible delay in product delivery. As another example, an actor can identify one or more other actors for performing additional actions. For example, if the vehicle involved in the accident is a part of a contractor's fleet, the supply chain management center (primary actor) can contact the contractor (secondary actor) to organize or execute road assistance actions. Action execution is monitored (316). For example, entities that have been assigned actions can provide result data to the enterprise, the result data indicating a status of an action (e.g., initiated, in-progress, completed). In some examples, the result data can include more detailed information regarding execution of the action(s).

Implementations of the present disclosure enable optimized reaction after an accident occurrence. According to the implementations of the present disclosure, the collection and processing of vehicle data enables an enterprise to automatically identify the occurrence of an accident and initiate actions to remediate the effects of the accident. In this manner, implementations of the present disclosure have a positive effect in helping the enterprises to provide efficient supply transportation in safer conditions.

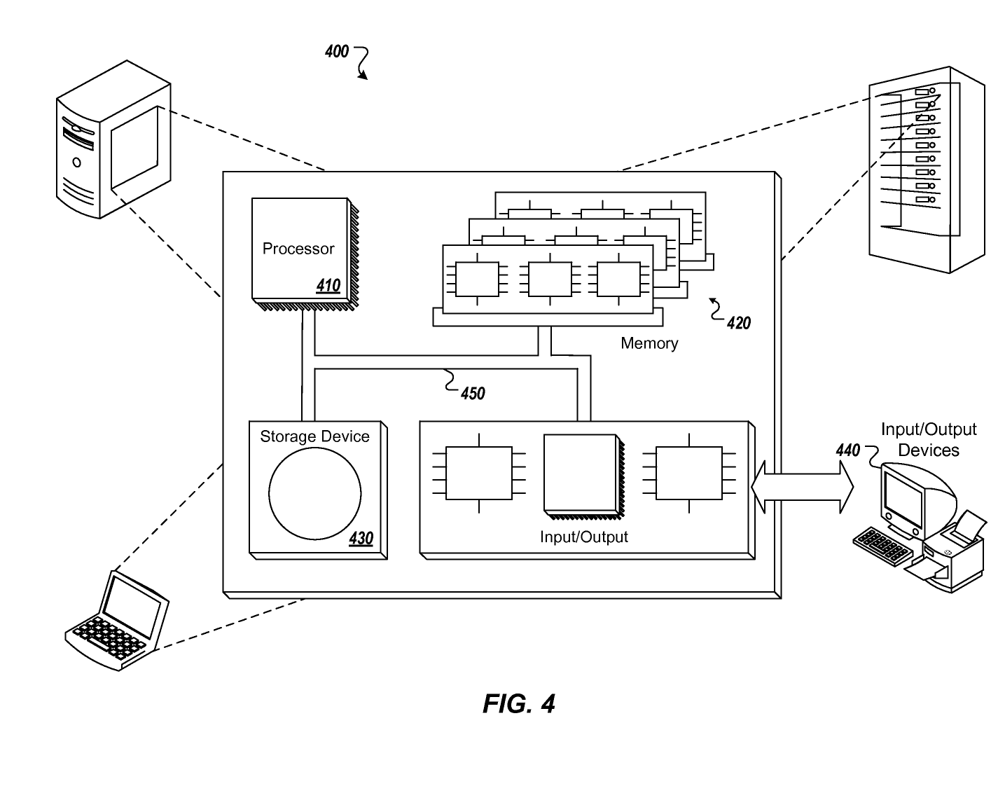

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. Each of the components (processor 410, memory 420, storage device 430, and input/output device 440) are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a backend component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automatically monitoring occurrence and initiating actions in response to accidents in operations of an enterprise, the method being executed using one or more processors and comprising:
receiving a plurality of vehicle data sets, each vehicle data set corresponding to a vehicle of a plurality of vehicles that support the operations of the enterprise;
receiving a first set of accident rules from a data repository;
processing, by the one or more processors, a first vehicle data set based on the first set of accident rules; and
determining, by the one or more processors, that a first vehicle corresponding to the first data set was in an accident, and in response:
determining one or more remedial actions to be performed,
identifying one or more entities, each entity performing at least one remedial action of the one or more remedial actions, and
transmitting a plurality of instruction data sets to the one or more entities, each entity of the one or more entities receiving at least one instruction data set.

2. The method of claim 1, further comprising receiving a set of action rules, wherein determining one or more remedial actions comprises processing data based on the one or more action rules.

3. The method of claim 2, wherein the data comprises at least a portion of data in the first vehicle data set, and additional data.

4. The method of claim 2, wherein the set of action rules is specific to at least one of a vehicle type of the first vehicle and a severity of the accident.

5. The method of claim 1, further comprising determining a severity of the accident based on the first vehicle data set, the one or more remedial actions being determined at least in part based on the severity of the accident.

6. The method of claim 1, wherein the one or more entities comprise at least one internal entity that is internal to the enterprise.

7. The method of claim 1, wherein the internal entity comprises one of a human resources department, a vehicle fleet maintenance department, a procurement department, a shipping department, a manufacturing department, a sales department, a legal department of the enterprise.

8. The method of claim 1, wherein the one or more remedial actions comprise at least one action that mitigates a delay in moving goods within a supply chain that the enterprise is a member of.

9. The method of claim 1, wherein the one or more entities comprise at least one external entity that is external to the enterprise.

10. The method of claim 9, wherein the external entity comprises at least one of an emergency service provider, a healthcare service provider, a police department, a fire department, an insurance provider, a vendor and a customer.

11. The method of claim 1, wherein data provided in the first vehicle data set comprises one or more of event data and operational data.

12. The method of claim 11, wherein the event data is indicative of one or more events comprising at least one of a crash, airbag deployment, rollover, windscreen breakage, wheel puncture, engine failure and transmission failure.

13. The method of claim 11, wherein the operational data comprises one or more of velocity, acceleration, braking, engine data and transmission data.

14. The method of claim 1, wherein the first set of accident rules is specific to a vehicle type of the first vehicle.

15. The method of claim 1, further comprising:
receiving a second set of accident rules from a data repository, the second set of accident rules being different from the first set of accident rules;
processing, by the one or more processors, a second vehicle data set based on the second set of accident rules; and
determining, by the one or more processors, that a second vehicle corresponding to the second data set was in an accident.

16. The method of claim 1, further comprising receiving, from each of the one or more entities, status data indicating statuses of respective executions of the one or more remedial actions.

17. The method of claim 16, further comprising determining additional actions to be performed based on the status data.

18. A non-transitory computer-readable storage medium coupled to one or more processors and having instructions stored thereon which, when executed by the one or more processors, cause the one or more processors to perform operations for automatically monitoring occurrence and initiating actions in response to accidents, the operations comprising:
receiving a plurality of vehicle data sets, each vehicle data set corresponding to a vehicle of a plurality of vehicles that support the operations of the enterprise;
receiving a set of accident rules from a data repository;
processing a vehicle data set based on the set of accident rules; and
determining that a vehicle corresponding to the data set was in an accident, and in response:
determining one or more remedial actions to be performed,
identifying one or more entities, each entity performing at least one remedial action of the one or more remedial actions, and
transmitting a plurality of instruction data sets to the one or more entities, each entity of the one or more entities receiving at least one instruction data set.

19. A system, comprising:
a computing device; and
a computer-readable storage device coupled to the computing device and having instructions stored thereon which, when executed by the computing device, cause the computing device to perform operations for automatically monitoring occurrence and initiating actions in response to accidents, the operations comprising:
receiving a plurality of vehicle data sets, each vehicle data set corresponding to a vehicle of a plurality of vehicles that support the operations of the enterprise;
receiving a set of accident rules from a data repository;
processing a vehicle data set based on the set of accident rules; and
determining that a vehicle corresponding to the data set was in an accident, and in response:
determining one or more remedial actions to be performed,
identifying one or more entities, each entity performing at least one remedial action of the one or more remedial actions, and
transmitting a plurality of instruction data sets to the one or more entities, each entity of the one or more entities receiving at least one instruction data set.
